(19) United States
(12) Patent Application Publication
(10) Pub. No.: US 2008/0113817 A1
(43) Pub. Date: May 15, 2008

(54) GAME CONSOLE PICTURE MANAGEMENT AND PRINTING SYSTEM

(76) Inventors: Richard A. Murray, San Diego, CA (US); John F. Manard, San Diego, CA (US); William C. Hilliard, Poway, CA (US)

Correspondence Address: David A. Novais;Patent Legal Staff, Eastman Kodak Company, 343 State Street, Rochester, NY, 14650-2201, US

(21) Appl. No.: 11/558,642

(22) Filed: Nov. 10, 2006

(51) Int. Cl. G06F 17/00; G06F 3/00

(52) U.S. Cl. 463/43; 710/13

(57) ABSTRACT

In a picture management and printing system, a game-console-accessible memory is provided with a set of instructions for a game console including or having communicatively connected thereto at least a display, a game controller, a second game-console-accessible memory, and a printer. The set of instructions at least causing the game console to assemble a picture repository from digital pictures, at least some of which are retained by the second game-console-accessible memory; and, responsive to input received from the game controller cause the game console to display a digital picture from the picture repository on the display and/or cause the game console to instruct the printer to print a digital picture from the picture repository.

### FIELD OF THE INVENTION

This invention relates to a game console picture management and printing system. In particular, the present invention pertains to managing and printing digital pictures using, among other things, a game controller communicatively connected to a game console.

### BACKGROUND OF THE INVENTION

The use of digital cameras has allowed users to take many more pictures than they have ever before. Consequently, users often find themselves with countless digital pictures stored in a myriad of locations: some pictures may be stored on the digital camera itself, some may be stored on a home desktop computer, some may be stored on a home laptop computer, and others may be stored by an on-line service, such as Kodak EasyShare Gallery™. Accordingly, a need in the art exists for convenient and simple ways for users to compile and manage their portfolio of digital pictures.

In addition to having a large quantity of digital images, users are also faced with a plethora of ways to obtain prints of their digital pictures. For example, users can bring a memory card from their digital camera to a local grocery store or pharmacy and have such store print their digital pictures. In addition, users can submit their digital pictures to an on-line service for printing. Another way for users to print their digital pictures is to use a home printing device, such as an ink jet printer. Commonly, users submit their digital pictures to the printer via a home computer or by connecting a memory card or the camera itself to the printer in order to print the digital images. While these options for printing digital pictures is convenient, there is still a need in the art for even more convenient ways for users to print their digital pictures.

### SUMMARY OF THE INVENTION

The above-described problems are addressed and a technical solution is achieved in the art by a game console picture management and printing system, according to embodiments of the present invention. According to an embodiment of the present invention, the system includes a printer, which may be an ink jet or a laser printer, and a game-console-accessible memory. The game-console-accessible memory may be removable media compatible with a game console. Consequently, implementations of the invention may be embodied on, for example, a disc compatible with the game console. Such disc and the printer may be sold separately or as a package to users at low cost, to allow them to simply and easily turn their home game consoles into digital picture management and printing devices.

According to an embodiment of the present invention, the game-console-accessible memory retains a set of instructions for a game console including or having communicatively connected thereto at least a display, a game controller, a second game-console-accessible memory, and the printer. The set of instructions includes picture import instructions, according to an embodiment of the present invention, configured at least to cause the game console to assemble a picture repository from digital pictures. According to an embodiment of the present invention, the picture import instructions are configured at least to cause the game console to assemble the picture repository in response to input received from the game controller. Consequently, embodiments of the present invention allow a user to conveniently assemble a picture repository via a game console, something with which users are already familiar.

According to an embodiment of the present invention, at least some of the digital pictures of the picture repository may be retained by the second game-console-accessible memory. In this regard, the second game-console-accessible memory may be a hard disk drive located within the game console. Alternatively, the second game-console-accessible memory may be external to the game console and the game console may include a data interface that, at least in part, communicatively connects the second game-console-accessible memory to the game console. In one embodiment, the data interface is a USB interface, and the second game-console-accessible memory is an external hard disk drive. In another embodiment, the data interface is a memory card reader, and the second game-console-accessible memory is a memory card.

Alternatively, according to another embodiment of the present invention, the second game-console-accessible memory is located within a remote computer and the data interface is a network interface. The network interface may be a wired network interface or a wireless network interface. Additionally, the computer may be a web server communicatively connected to the game console via the network interface and the Internet. In this case, a user may be able to manage and print digital images stored by an on-line picture management service, such as Kodak EasyShare Gallery, from the convenience of the user's own home game console.

According to an embodiment of the present invention, the set of instructions also includes picture display instructions configured at least to, responsive to input received from the game controller, cause the game console to display the digital picture from the picture repository from the display. The display instructions may be configured at least to, responsive to input received from the game controller, cause the game console to display a plurality from digital pictures from the picture repository simultaneously from on the display.

According to an embodiment of the present invention, the set of instructions may also include picture editing instructions configured at least to, responsive to input received from the game controller, cause the game console to edit a digital picture (“edited digital picture”) from the picture repository that is displayed on the display. Such edits may be saved by the game console to the picture repository. Consequently, these embodiments allow a user not only to assemble a picture repository from the convenience of the user's own game console, but also to review and manage the pictures therein.

According to another embodiment of the present invention, the set of instructions also includes picture-printing instructions configured at least to, responsive to input received from the game controller, cause the game console to instruct the printer to print a digital picture from the picture repository. In this regard, a user can easily print pictures from the user's game console via a printer attached thereto.

According to yet another embodiment of the present invention, the printing instructions, when causing the game console to instruct the printer to print a digital picture (“selected digital pictures”) from the picture repository, may also be configured to perform all or substantially all image processing on the selected digital picture necessary for the printer to print the selected digital picture. In addition or alternatively, the printing instructions may include a printer driver for the printer. Accordingly, it is possible for the printer to be produced at low cost by including therein minimal or reduced internal processing capabilities.

In addition to the embodiments described above, further embodiments will become apparent by reference to the drawings and by the study of the following detailed description.

### BRIEF DESCRIPTION OF THE DRAWINGS

The present invention will be more readily understood from the detailed description of exemplary embodiments presented below considered in conjunction with the attached drawings, of which:

FIG. 1 illustrates a picture-management and printing system, according to an embodiment of the present invention;

FIG. 2 illustrates a game-console-accessible memory and at least some of the set of instructions included therein, according to an embodiment of the present invention;

FIG. 3 illustrates a second game-console-accessible memory retaining at least a portion of a picture repository therein, according to an embodiment of the present invention;

FIG. 4 illustrates navigation through a plurality of digital pictures stored in the picture repository and viewed on a display, according to an embodiment of the present invention; and

FIG. 5 illustrates the editing of a digital picture from the picture repository on a display, according to an embodiment of the present invention.

It is to be understood that the attached drawings are for the purpose of illustrating the concepts of the invention and may not be to scale.

### DETAILED DESCRIPTION

Embodiments of the present invention recognize that game consoles provide a effective solution to digital picture management and printing, because game consoles are owned by, familiar to, and easily accessible to many users. Accordingly, embodiments of the present invention allow users to assemble a digital picture repository, view and manage their digital pictures in the repository, and print their digital pictures to a printer communicatively connected to the game console. Embodiments of the present invention achieve these results by, among other things, providing a game-console-accessible memory and a printer configured to communicatively connect to the game console. The game-console-accessible memory includes software that configures the game console to perform digital picture management and printing functions. The game-console-accessible memory may be removable media compatible with the game console. As such, implementations of the invention may be embodied on, for example, a disc compatible with the game console. Consequently, such disc and the printer, among other things, may be sold separately or as a package to users at low cost, to allow them to simply and easily turn their home game consoles into digital picture management and printing devices.

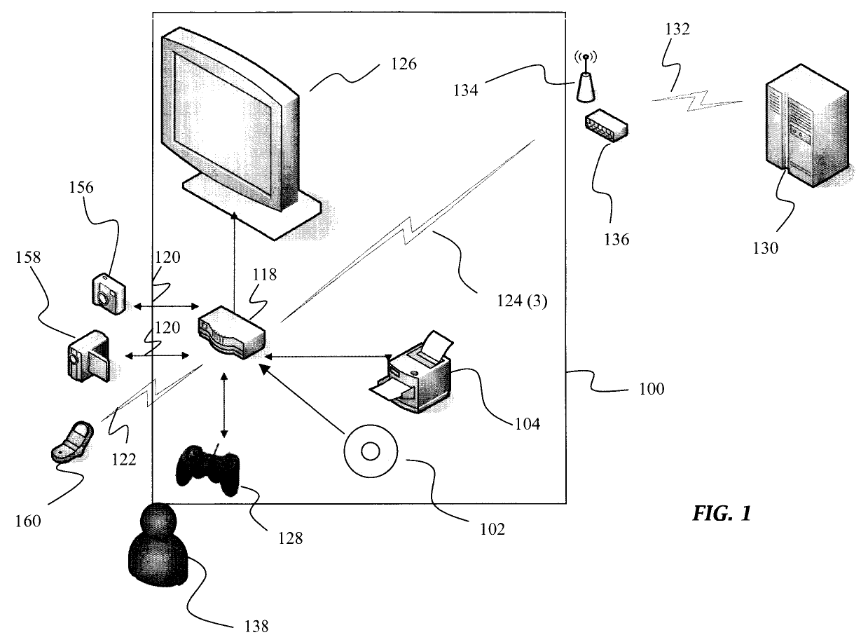

Turning now to FIG. 1, a picture management and printing system 100 is illustrated, according to an embodiment of the present invention. The system 100, according to this embodiment, includes a game console 118 with a game controller 128 communicatively connected thereto. Although the game console 118 is illustrated in FIG. 1 as a set-top box game console of the nature of current Xbox 360™ and Playstation 3™ devices, one skilled in the art will appreciate that the present invention includes within its scope portable game consoles, such as the PlayStation PSP™, and even game-enabled cellular phones capable of implementing the functionality of the game console 118 described herein. In this regard, although FIG. 1 illustrates a display 126 located separate from the game console 118, one skilled in the art will appreciate that it may be integrated with the game console 1118.

Further, although FIG. 1 illustrates the game controller 128 as a hand-held button-based device, one skilled in the art will appreciate that the present invention includes within its scope any type of game controller capable of interacting with the game console 118 in the manners described herein. For example, the game controller 128 could be a voice-activated headset, a touch screen display, etc. In the case of a touch screen display, one skilled in the art will appreciate that, although FIG. 1 illustrates the display 126 as being separate from the game controller 128, the display 126 and the game controller 128 may be integrated.

The phrase “communicatively connected” is intended to include any type of connection, whether wired, wireless or both, between devices and/or programs in which data may be communicated. Further, the phrase “communicatively connected” is intended to include a connection between devices and a connection between components within a device. In this regard, although some of the components in the figures are shown as separate entities, one skilled in the art will appreciate that such separate components may actually be located within the same device.

The picture management and printing system 100, according to the embodiment of FIG. 1 also includes a printer 104, which may, for example, be an ink jet printer, configured at least to print digital pictures. The printer 104 is communicatively connected to the game console 118 via data interfaces: one on the game console 118 and one on the printer 104. For example, the printer 104 and the game console 118 may be communicatively connected via wired or wireless USB, Ethernet, Wifi, Bluetooth, etc.

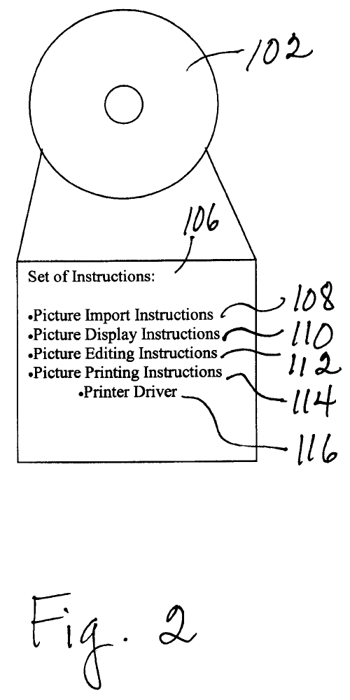

The system 100, according to this embodiment, also includes a game-console-accessible memory 102. The phrase “game-console-accessible memory” is intended to include any data storage device accessible by the game console 118, whether volatile or non-volatile, electronic, magnetic, optical, or otherwise, including by not limited to, floppy discs, hard disk drives, thumb drives, compact discs, DVDs, flash memories, ROMs, and RAMs. In this regard, the memory 102 may be removable media compatible with the game console 118, such as, for example, a disc compatible with the game console 118. However, although FIGS. 1 and 2 illustrate the game-console-accessible memory as being external media compatible with the game console 118, one skilled in the art will appreciate that the game-console-accessible memory may be internal to the game console 118, such as all or a portion of an internal hard disk drive or other memory of the game console 118. In this case, instructions stored on an internal memory of the game console 118 may be deposited into the internal memory via any number of techniques, including loading such instructions into the internal memory from an external memory, such as a disc or flash memory, or downloading such instructions from a network connection.

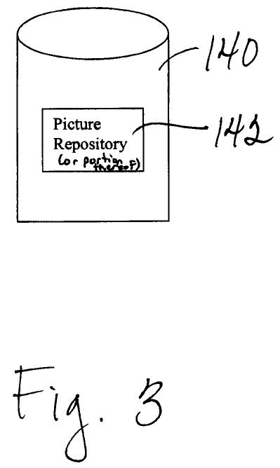

FIG. 2 illustrates a close-up view of the game-console-accessible memory 102, and illustrates that such memory 102 includes therewith a set of instructions 106 for the game console 118. The set of instructions 106 includes picture import instructions 108 configured at least to cause the game console to assemble a digital picture repository 142 from digital pictures, at least some of which are retained by a second game-console-accessible memory 140 shown in FIG. 3.

For example, when a user inserts the memory 102 into the game console 118, according to an embodiment of the present invention, the picture import instructions 108 instruct the game console 118 to compile digital pictures to form a picture repository. At least some of the digital pictures are stored in the second game-console-accessible memory 140. The assembly of the picture repository 142 may occur by way of interaction from the user 138 via inputs received from the game controller 128. Alternatively or in addition, the assembly of the picture repository 142 may occur automatically by instructing the game console to query all communicatively attached devices that have game-console-accessible memories that may have digital pictures stored therein.

In this regard, the second game-console-accessible memory 140 may be stored in any number of locations or devices. For example, the second memory 140 may be an internal hard disk drive located within the game console 118. Alternatively, the second memory 140 may be located external to the game console 118. In this case, the game console 118 includes a data interface for communicatively connected to the external memory. For example, the second memory 140 may be an external hard disk drive located in a computer 130. In this example, the game console 118 may include a data interface that is a wireless network interface 124 that communicatively connects the game console 118 to the computer 130 via a wireless access point 134, a wireless router 136, and the Internet 132. If the computer 130 is a web server, the user 138 may have access to digital pictures retained by an on-line picture management and printing service, such as Kodak EasyShare Gallery, via the game console 118. It should be noted that although FIG. 1 is illustrated in the context of a wireless network interface 124 between the computer 130 and the game console 118, one skilled in the art will appreciate that a wired network interface, such as an Ethernet interface, may alternatively be used.

Further in this regard, one skilled in the art will appreciate that instead of having a wireless network interface 124, the game console 118 can have other or additional data interfaces. For example, the game console 118 may include one or more USB interfaces 120 that communicatively connect the game console 118 to a digital camera 156 or a digital video recorder 158, or other image acquisition devices. Alternatively or in addition, the game console 118 may include, as a data interface, a wireless interface 122, such as a Bluetooth, WUSB (wireless USB), or UWB interface that communicatively connects the game console to a cellular phone 160.

Still further in this regard, one skilled in the art will appreciate that there may be several second game-console-accessible memories like memory 140, that are located in any number of devices, such as the computer 130, the digital camera 156, the digital video recorder 158, and the cellular phone 160.

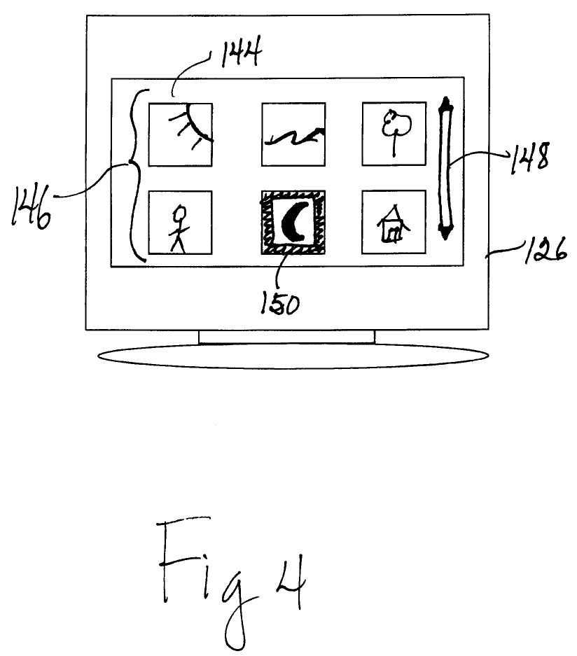

Returning to the embodiment of FIG. 2, the set of instructions 106 stored by the game-console-accessible memory 102 also includes picture display instructions 110. The picture display instructions are configured at least to, responsive to input received from the game controller 128, cause the game console 118 to display a digital picture from the picture repository 142 on a display 126, which is communicatively connected to the game console 118. According to an embodiment of the present invention shown in FIG. 4, the picture display instructions 110 may be configured at least to cause the game console 118 to display a plurality of digital pictures 146 on the display 126. Reference numeral 144 represents a single digital picture, as opposed to the plurality 146. Using the controller 128, the user 138 may navigate the digital pictures 146 shown on the display 128. In this regard, a scroll bar 148 may be used to facilitate such navigation and/or to indicate to the user 138 that additional pictures are included in the picture repository 142 that are not currently on the display 126. The user 138, via the game controller 128 can then scroll up and scroll down to display other digital pictures. While navigating, a plurality of different pictures can be displayed simultaneously as the user scrolls through the digital pictures in the picture repository 142.

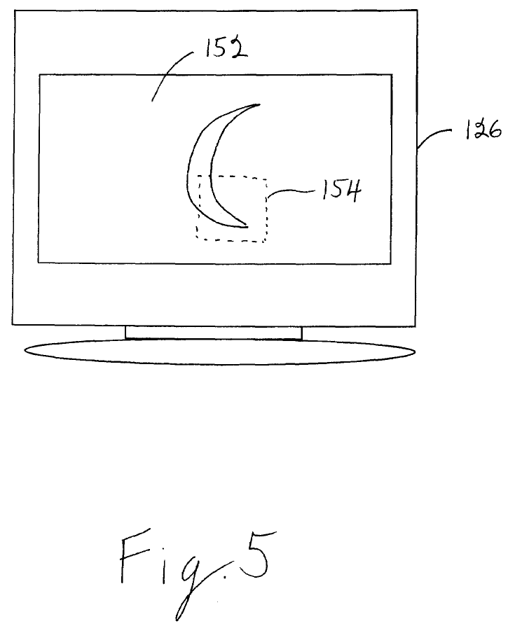

Returning to the embodiment of FIG. 2, the set of instructions 106 stored by the game-console-accessible memory 102 also includes picture editing instructions 112. The embodiment of FIG. 4 illustrates, for example, how these instructions may be invoked. In particular, the embodiment of FIG. 4 illustrates a picture 150 that is currently highlighted by the user 138 via the game controller 128. Upon selection of the highlighted digital picture 150, such as by the user 138 selecting a button on the controller 128, the picture editing instructions 112 may be invoked. Such instructions 112, according to an embodiment of the present invention, provide a zoom-in of the highlighted picture 150 to allow the user to personally edit fine details of such picture. The edited picture 152, shown in FIG. 5, may be edited in detail to attain personal design intent in any variety of ways such as cropping, adjustment of brightness, adjustment of contrast, application of filters, and the detailed use of image-editing tools. One skilled in the art will appreciate that the invention is not limited to any particular editing technique used to edit the digital picture 152. Cropping, as an example of editing, is shown by dotted square 154 in FIG. 5. Upon completion of the editing of the picture 152 the picture editing instructions may, responsive to input received from the game controller 128, instruct the game controller 118 to save the changes to the picture repository 142.

Returning to the embodiment of FIG. 2, the set of instructions 106, also includes picture-printing instructions 114. The picture printing instructions, according to this embodiment, are configured at least to, responsive to input received from the game controller 128, cause the game console 118 to instruct the printer 104 to print a digital picture 144 from the picture repository 142. For example, the highlighted digital picture 150 in FIG. 4 may be indicated by the user 138 via game controller 128 for printing by the printer 104. In this case, the game console 118 instructs the printer 104 communicatively connected thereto to print the highlighted digital picture 150.

According to an embodiment of the present invention, the game console, as instructed by the picture printing instructions 114, performs all or substantially all of the image processing necessary for the printer 104 to print the highlighted digital picture 150. For example, the game console 118 may be instructed to perform all image processing required to generate rasterized swath print data known in the art that the game console 118 transmits to the printer 104 for printing. On the other hand, the game console 118 may be instructed to perform scaling, color conversions, dithering, rasterizing, generation of ready-to-print data, or combinations thereof. Examples of image enhancements include automatic contrast adjustment and red-eye reduction. In this regard, the picture printing instructions 114 may include therein a printer driver 116, shown in FIG. 2, for the printer 104. Further in this regard, the printer 104 may include electronics configured to control a printing mechanism within the printer 104 to print the image data without the electronics performing additional or substantially additional image processing of image data received from the game console 118. An advantage of this arrangement, although not required, is that the printer 104 may be produced at lower cost than conventional printers because it requires minimal or reduced processing power/electronics and associated internal memory support over such conventional printers. Also, the use of the display 126 provides an improved user interface over conventional interfaces located on conventional printers, such as buttons on a conventional printer. Accordingly, the display 126 may eliminate the need for user data-input and output interfaces to be built into the printer 104.

It is to be understood that the exemplary embodiments are merely illustrative of the present invention and that many variations of the above-described embodiments can be derived by one skilled in the art without departing from the scope of the invention. It is therefore intended that all such variations be included within the scope of the following claims and their equivalents.

### Parts List

100 Picture management and printing system
102 Game-console-accessible memory
104 Printer
106 Set of instructions
108 Picture import instructions
110 Picture display instructions
112 Picture editing instructions
114 Picture printing instructions
116 Printer driver
118 Game console
120 USB interface
122 Wireless interface
124 Network interface
126 Display
128 Game controller
130 Computer housing external hard disk drive
132 Internet connected to computer and game
134 Wireless access point
136 Wireless router
138 User
140 Second game-console-accessible memory
142 Picture repository
144 Digital picture
146 Plurality of digital pictures displayed simultaneously
148 Scroll bar
150 Selected digital picture
152 Edited (and saved) digital picture
154 Crop

What is claimed is:

1. A game-console-accessible memory retaining a set of instructions for a game console including or having communicatively connected thereto at least a display, a game controller, a second game-console-accessible memory, and a printer, the set of instructions comprising:
a) picture import instructions configured at least to cause the game console to assemble a picture repository from digital pictures, at least some of which are retained by the second game-console-accessible memory;
b) picture display instructions configured at least to, responsive to input received from the game controller, cause the game console to display a digital picture from the picture repository on the display; and
c) picture printing instructions configured at least to, responsive to input received from the game controller, cause the game console to instruct the printer to print a digital picture from the picture repository.

2. The game-console-accessible memory of claim 1, wherein the picture import instructions are configured at least to cause the game console to assemble the picture repository in response to input received from the game controller.

3. The game-console-accessible memory of claim 1, wherein the picture display instructions are configured at least to, responsive to input received from the game controller, cause the game console to display a plurality of digital pictures from the picture repository simultaneously on the display.

4. The game-console-accessible memory of claim 3, wherein the picture display instructions are configured at least to, responsive to input received from the game controller, cause the game console to display different pluralities of digital pictures from the picture repository simultaneously on the display.

5. The game-console-accessible memory of claim 1, wherein the printing instructions comprise a printer driver for the printer.

6. The game-console-accessible memory of claim 1, wherein the printing instructions, when causing the game console to instruct the printer to print a digital picture (“selected digital picture”) from the picture repository, are configured at least to perform all or substantially all image processing on the selected digital picture necessary for the printer to print the selected digital picture.

7. The game-console-accessible memory of claim 1, further comprising picture editing instructions configured at least to, responsive to input received from the game controller, cause the game console to edit a digital picture (“edited digital picture”) from the picture repository that is displayed on the display.

8. The game-console-accessible memory of claim 7, wherein the picture editing instructions are further configured at least to, responsive to input received from the game controller, cause the game console to save edits made to the edited digital picture on the second game-console-accessible memory.

9. The game-console-accessible memory of claim 1, wherein the game-console-accessible memory is removable media compatible with the game console.

10. The game-console-accessible memory of claim 9, wherein the game-console-accessible memory is a disc compatible with the game console.

11. The game-console-accessible memory of claim 1, wherein the second game-console-accessible memory is a hard disk drive located within the game console.

12. The game-console-accessible memory of claim 1, wherein the second game-console-accessible memory is external to the game console and the game console includes a data interface that, at least in part, communicatively connects the second game-console-accessible memory to the game console.

13. The game-console-accessible memory of claim 12, wherein the data interface is a USB interface and the second game-console-accessible memory is an external hard disk drive.

14. The game-console-accessible memory of claim 12, wherein the second game-console-accessible memory is located within a computer and the data interface is a network interface.

15. The game-console-accessible memory of claim 14, wherein the network interface is a wired network interface.

16. The game-console-accessible memory of claim 15, wherein the network interface is an Ethernet interface.

17. The game-console-accessible memory of claim 14, wherein the network interface is a wireless network interface.

18. The game-console-accessible memory of claim 14, wherein the computer is a web-server communicatively connected to the game console via the network interface and the Internet.

19. A picture-management and printing system, the system comprising:
a printer; and
a game-console-accessible memory retaining a set of instructions for a game console including or having communicatively connected thereto at least a display, a game controller, a second game-console-accessible memory, and the printer, the set of instructions comprising:
a) picture import instructions configured at least to cause the game console to assemble a picture repository from digital pictures, at least some of which are retained by the second game-console-accessible memory;
b) picture display instructions configured at least to, responsive to input received from the game controller, cause the game console to display a digital picture from the picture repository on the display; and
c) picture printing instructions configured at least to, responsive to input received from the game controller, cause the game console to instruct the printer to print a digital picture from the picture repository.

20. The system of claim 19, wherein the printer is configured to communicatively connect to the game console via a USB, WUSB, Ethernet, Bluetooth, or WiFi connection.

21. The system of claim 19, wherein the printer is an ink-jet printer.

22. The system of claim 19, wherein the picture import instructions are configured at least to cause the game console to assemble the picture repository in response to input received from the game controller.

23. The system of claim 19, wherein the picture display instructions are configured at least to, responsive to input received from the game controller, cause the game console to display a plurality of digital pictures from the picture repository simultaneously on the display.

24. The system of claim 19, wherein the printing instructions comprise a printer driver for the printer.

25. The system of claim 19, wherein the printing instructions, when causing the game console to instruct the printer to print a digital picture (“selected digital picture”) from the picture repository, are configured at least to perform all or substantially all image processing on the selected digital picture necessary for the printer to print the selected digital picture.

26. The system of claim 19, further comprising picture editing instructions configured at least to, responsive to input received from the game controller, cause the game console to edit a digital picture (“edited digital picture”) from the picture repository that is displayed on the display.

27. The system of claim 19, wherein the game-console-accessible memory is removable media compatible with the game console.

28. The system of claim 27, wherein the game-console-accessible memory is a disc compatible with the game console.

29. The system of claim 19, wherein the second game-console-accessible memory is a hard disk drive located within the game console.

30. The system of claim 19, wherein the second game-console-accessible memory is external to the game console and the game console includes a data interface that, at least in part, communicatively connects the second game-console-accessible memory to the game console.

31. The system of claim 30, wherein the data interface is a USB interface and the second game-console-accessible memory is an external hard disk drive.

32. The system of claim 30, wherein the second game-console-accessible memory is located within a computer and the data interface is a network interface.

33. The system of claim 32, wherein the network interface is a wired network interface.

34. The system of claim 33, wherein the network interface is an Ethernet interface.

35. The system of claim 32, wherein the network interface is a wireless network interface.

36. The system of claim 32, wherein the computer is a web-server communicatively connected to the game console via the network interface and the Internet.

37. A printer comprising:
a printing mechanism;
a data interface configured to communicatively connect to a game console and receive image data from the game console; and
electronics configured to control the printing mechanism to print the image data without the electronics performing additional or substantially additional image processing of the image data after the image data is received by the data interface.

38. The printer of claim 37, wherein the printer does not include user data-input interfaces.

39. A game-console executed method comprising the steps of:
instructing assembling a picture repository from digital pictures, at least some of which are retained by a game-console-accessible memory;
instructing displaying, responsive to input received from a game controller, a digital picture from the picture repository on a display; and
instructing printing, responsive to input received from the game controller, a digital picture from the picture repository.
